(19) United States
(12) Patent Application Publication
(10) Pub. No.: US 2004/0172287 A1
(43) Pub. Date: Sep. 2, 2004

(54) Method and apparatus for obtaining and distributing healthcare information

(76) Inventors: Michael O'Toole, Hinsdale, IL (US); Vincent Bufalino, Glen Ellyn, IL (US); Louis McKeever, Burr Ridge, IL (US); Joseph Marek, Oak Brook, IL (US); Mark Goodwin, Naperville, IL (US); Lloyd E. Shefsky, Highland Park, IL (US)

Correspondence Address: VEDDER PRICE KAUFMAN & KAMMHOLZ, 222 N. LASALLE STREET, CHICAGO, IL, 60601, US

(21) Appl. No.: 10/370,250

(22) Filed: Feb. 19, 2003

(51) Int. Cl. G06F 17/60

(52) U.S. Cl. 705/2

(57) ABSTRACT

Patient data is collected by point-of-care terminals and uploaded to a computer where it is processed. The processed patient data can be analyzed by the computer to yield clinical information. The results of the analyses performed by the computer can be re-distributed to health care providers, patients, or other third parties.

### BACKGROUND

Present-day medical care typically entails the administration of one or more treatment regimens, followed by patient monitoring and adjustment of the treatment regimen. Whether a medical treatment for a diagnosed illness is new or old, information about the efficacy of a particular treatment and whether it might be appropriate or effective on a particular patient is often stale. In other words, information about the effectiveness a treatment is often out-dated.

At least one problem with present-day medical practice is that data concerning the efficacy of a treatment or medicine is not collected or processed and re-distributed to the medical community. Useful information on the efficacy of a medical treatment is typically obtained from data that is collected in connection with specific studies, typically by academia, pharmaceutical manufacturers or government-funded research. Useful knowledge on the efficacy of a medical treatment could be uncovered and disseminated more quickly by way of an automated method and apparatus by which actual health care data is quickly obtained, processed and distributed to enhance medical treatment would be an improvement over the prior art. Distributing actual results that patients and health care providers have obtained from various treatments would provide a feedback to medical professionals and health care providers by which treatments might be altered so as to improve health care services at a lower cost.

### BRIEF DESCRIPTION OF THE DRAWINGS

FIG. 1 shows a blocked diagram of a system for obtaining and distributing healthcare information.

FIG. 2 shows a depiction of a point-of-care data terminal for use in collecting patient data.

FIG. 3 shows a depiction of a data structure, the organization of which determines the location of certain patient information.

FIG. 4 shows a depiction of a computer, functions of which are determined by instructions stored in memory and which include: receiving patient data; processing patient data and distributing processed patient data.

FIG. 5 shows a flow chart depicting a process for obtaining patient data, processing it, extracting information and outputting the results.

### DETAILED DESCRIPTION OF THE PREFERRED EMBODIMENTS

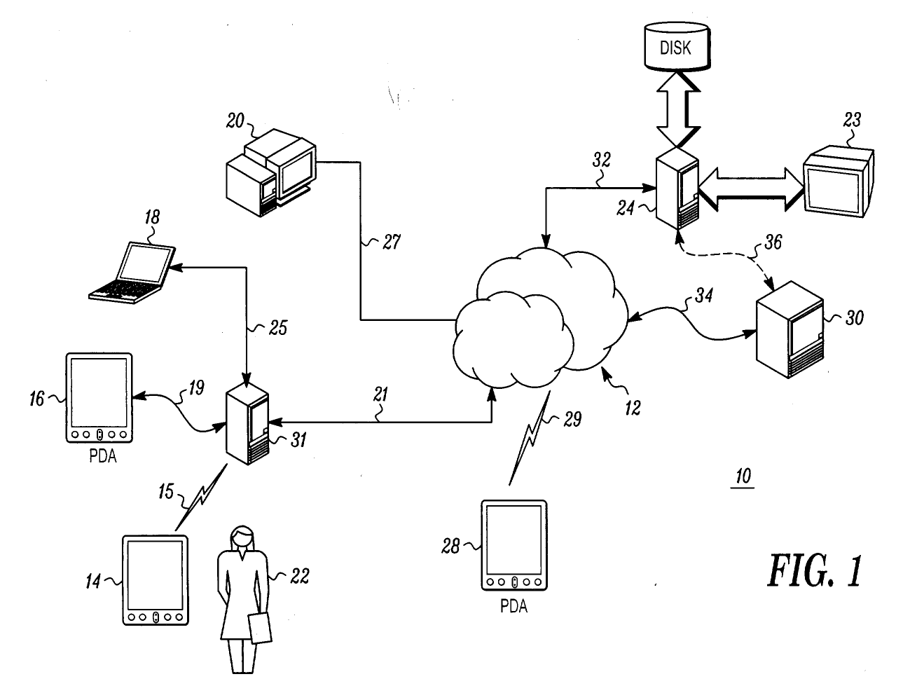

FIG. 1 shows a system 10 for obtaining patient data, processing the patient data into healthcare knowledge and information and distributing the knowledge and information via a data network. The system 10 has three principal components: at least one data network 12; several point-of-care data collection terminals or systems 14, 16, 18, 20 and 28; and one or more computers or servers the function(s) of which is (are) to collect and process patient data.

On the Internet and for purposes of this disclosure, a “server” is considered to be a network-connected computer and/or program running on a computer, which responds to commands from a client computer. For instance, a file server may be a computer, containing an archive of data or program files such that when a client computer submits a request for a file, the file server transfers a copy of the file to the client via a connection or network that extends between the client computer and the server computer.

One server is identified in FIG. 1 by reference numeral 24, another server is identified in FIG. 1 by reference numeral 31. Both servers 24 and 31 are depicted in FIG. 1 as computers. Both servers 24 and 31 are considered to be data “collection/processing computers” and “collection/processing servers.”

In the system 10 of FIG. 1, patient data is collected from a patient or from patient records at points-of-care using data terminals 14, 16, 18, 20 and 28, which are pre-programmed and/or otherwise designed to aid clinical data input and reduce the likelihood of data entry mistakes. In one embodiment of the invention disclosed herein, patient data that is entered into the data terminals 14, 16 and 18 is first electronically transmitted to a local data collection server 31 at which the clinical patient data can be stored and processed as described more fully below.

The server 31 is referred to as a “local collection server” because it provides server functionality to a limited number of clients (i.e., the point-of-care data collection terminals 14, 16 and 18) via a limited-access network such as a local area network or LAN within a medical practice group, office, hospital, patient's or health care provider's residence.

The processes that the local data collection server 31 can perform include collecting test data, such as numeric test results, medications that the patient is taking or has taken, or should be taking. The server 31 can also collect a health care provider's diagnosis; an evaluation or an opinion, whether in the form of text strings entered into a terminal, voice stored as one or more WAV (or equivalent) files; data, representing recognized speech. By appropriately programming the local data collection server 31, like the remote server 24 it can act as an “expert” by querying a user for data input; analyzing input data and re-querying a user for additional data based on previous inputs. It can be programmed to recommend certain courses of action that is suggested by the data input to it, and/or make or suggest diagnoses based on programmed analyses of data obtained from patients and which data is repeatedly augmented with more data to recursively update medical treatments suggested by the patient data that the server 24 operates on.

Like the processing that can be performed on the server 31, patient data can be processed on a remotely located server 24. In the system 10 of FIG. 1, patient data is carried via a data link 21 to a data network 12, such as the Internet. Using well-known data transport protocols, such as the data transport protocols used on the Internet, patient data is routed through the network 12 to a server/computer 24 where the patient data can be additionally, or initially processed to improve the efficacy of medical treatments. From the second server 24, processed patient data can be distributed in a variety of directions.

In one embodiment, patient data processed by the server 24 can be “pushed down” (i.e., electronically distributed from the server) via the data network 12 to one or more health care providers as a sort of feedback signal or feedback information by which the efficacy of medical treatment regimens as evaluated by server software 24 operating on patient data that was sent to it. The processed patient data can also be distributed to third party patient data consumers, such as insurance providers, governmental agencies, researchers, pharmaceutical manufacturers, schools and patients.

For purposes of claim construction, “patient data” includes clinical information such as test data or results; a diagnosis or diagnoses; medication that the patient has taken in the past, is taking or should consider taking in the future. “Patient data” can also include a medical history. “Patient data” can also include the notes, diagnoses, instructions to a patient, comments, observations, evaluations or opinions of a health care provider, specifically including state-licensed, medical professionals, whether provided to the patient or not. “Patient data” can also include information that identifies a medical treatment provided to a patient by a health care provider. “Patient data” would include a person's medical history, personal data such as his or her lifestyle, age, as well as the demise of the patient. “Patient data” can also include information that identifies a patient, where he or she lives, and the provider of a medical treatment.

After patient data is processed by the computer/server 24, the patient data becomes “processed patient data” examples of which would include, but are not limited to, new, evidence-based medical treatment guidelines; evidence-based research and results, and evidence-based treatments where the evidence is comprised of data provided by health care providers and obtained from real patients. “Processed patient data” would also include data and/or statistics showing the efficacy of medical treatments (reported to the servers 24 and/or 31) rendered to patients; data and/or statistics showing potential ill side-effects of combinations of medical therapies; warnings or advisories of potential risks of certain medical treatments, gleaned from patient data or announced by governmental agencies, medical researchers or pharmaceutical manufacturers. Processed patient data can be posted by the computer/server 24 to a web page, or electronically transmitted, such as by way of an e-mail message, to health care providers, patients or other third parties as one or more data files. As such, the computer 24, which can function as a server, can also function as a web site or web page server, making available via the Internet, information gleaned from patient data processing.

For purposes of claim construction, a “patient” is considered to be a person contemplating treatment or actually receiving medical, psychiatric, chiropractic or dental care by one or more health care providers. A “health care provider” is considered to be any person who administers any form of health care, specifically including state-licensed practitioners such as medical doctors. The term “health care provider” therefore includes, but is not limited to: licensed medical doctors, dentists, nurses, podiatrists, laboratory and test technicians and therapists. In some circumstances, and for purposes of claim construction, in addition to the aforementioned individuals, a “health care provider” can include the patient himself or herself and/or family members or other individuals who render or assist in the rendering of health care. “Health care” is considered to be any sort of treatment or therapy administered, ordered or authorized by a “health care provider,” including drug therapy regardless of the form of its administration, surgery, counseling, etc.

In the system 10 of FIG. 1, “patient data” is obtained from a patient by a health care provider 22 using a point-of-care data terminal 14, 16, 18, 20 and 28. The point-of-care data terminals provide a computer-controlled data terminal mechanism and can be embodied as VERICIS™ terminals available from Camtronics Medical Systems, as of the filing date located at 900 Walnut Ridge Drive, Hartland, Wis., 53029.

Point-of-care data terminals such as the VERICIS™ terminals facilitate unambiguous information/data collection regarding medical treatment provided to a person by a health care provider, in part by way of defined, data-input templates implemented on the point-of-care data terminals by software and which requires consistent data inputs. Requiring input data to conform to a template helps to insure the accuracy of input data and it's legibility at a later date, thereby enhancing patient care and safety.

In one embodiment, patient data can be temporarily stored in the point-of-care data terminal, before or after being formatted into one or more pre-determined-structure data files or data structures for transmission to a patient data processing computer 24. In a preferred embodiment, the point-of-care terminal acts as a terminal to one or more other servers 24 and/or 31. No patient data is stored on the point-of-care terminal other than that which is necessary to provide a display on the point-of-care monitor or screen in order to insure that patient data is not compromised or lost with a terminal device. Patient data is preferably kept on a server 24 or 31 for security purposes and securely transferred to and from the point-of-care terminal wirelessly or via a hardwired connection.

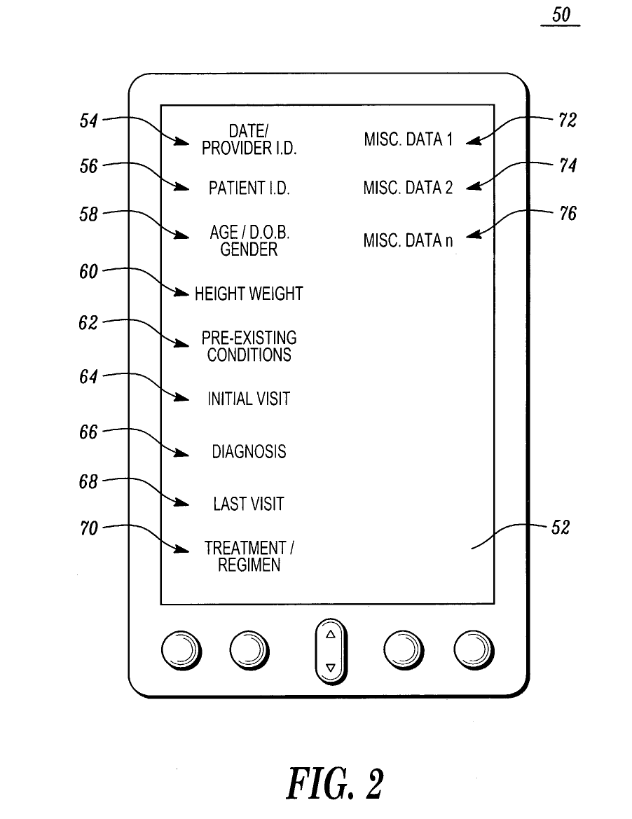

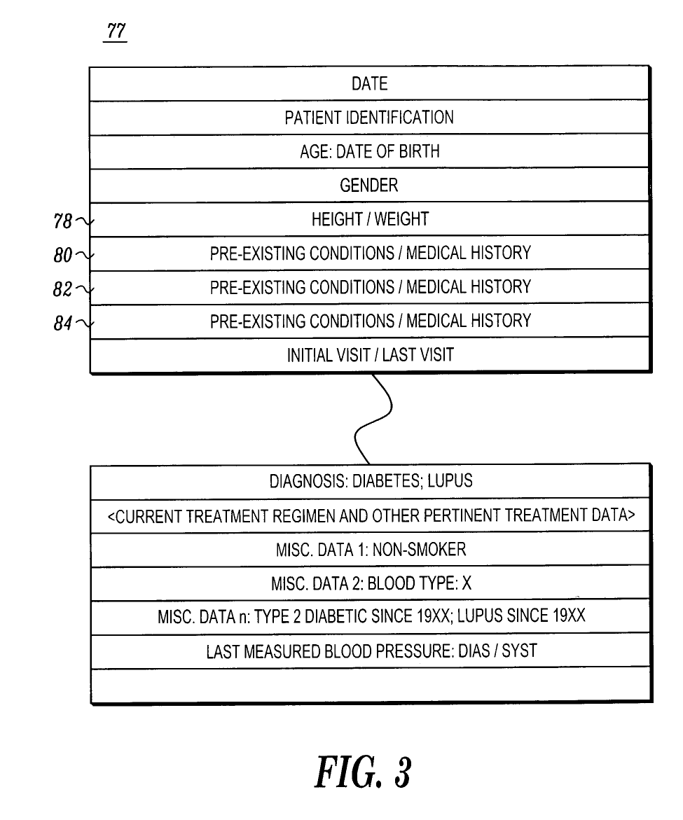

FIG. 2 depicts one example of a PDA-like point-of-care data terminal 50 for use with the system 10 depicted in FIG. 1. The point-of-care data terminal 50 provides the functionally by which patient data related to treatment provided to a patient by a health care provider is electronically collected and organized into one or more data files, each of which has a predetermined structure and organization as shown in FIG. 3.

Data can be input to the point-of-care data terminal 50 depicted in FIG. 2 by a variety of techniques including, but not limited to a touch sensitive input/display screen 52 into which handwritten key strokes are input and echoed (i.e., displayed). Patient data can also be input using hand-written notes, scanned images, bar coding, voice recordation (e.g., a WAV file) and voice recognition by which speech is converted to data for storage. Data can be input by a health care provider, a patient or a patient surrogate.

Key strokes can be input using a pen or stylus such as that used with well-known personal digital assistance; key strokes are echoed (displayed) after they are recognized by the data terminal 50 processor (not shown). Software within the data terminal 50 can intelligently specify what sorts of information should be collected from the patient in a methodology similar to an “expert system.” For instance, a patient with certain medical conditions would result in the system prompting additional data input. Additional input data can result in feedback information to a health care provider to assist a medical care provider, medical research or other aspects of patient care.

The point-of-care data terminal 50 is shown in FIG. 2 as displaying examples of patient data that can serve to identify a medical treatment provided to the patient. As such, “patient data” can include: a patient identifier, a date upon which a service is rendered and/or a healthcare provider identifier 54. “Patient data” can include a full or partial medical history. “Patient data” can include but is not limited to: a patient's age or date of birth 58; the patients height and/or weight 60; pre-existing medical conditions 62; the date of the patient's initial visit 64; a medical diagnosis 66; the date of the patients last visit 68; a description of the patients treatment and/or treatment regimen 70. Miscellaneous data fields 72, 74 and 76 can be included in the point-of-care data terminal to provide other data that might be pertinent to a particular patient and/or his/her diagnosis and/or treatment.

Patient data collected by the point-of-care terminal 50 is stored in data structures, the organization of which is predetermined in order to facilitate the subsequent processing of the data by the computer 24. An example of a data structure is shown in FIG. 3 and identified by reference numeral 70. Different pieces of patient data obtained using a point-of-care data terminal are organized in the data structure 70 as shown, but only for purposes of illustration.

Items of patient data in the data structure 70, such as a patient's medical history, height and/or weight in field 78 will typically require several bytes of information stored within the point-of-care data terminal. Pre-existing conditions or a prior medical history of a patient 80, 82, 84 will usually require several hundred bytes of storage space or more. By knowing the structure and organization of a patient data file 70, the patient data processing computer 24 can locate information of particular significance or interest.

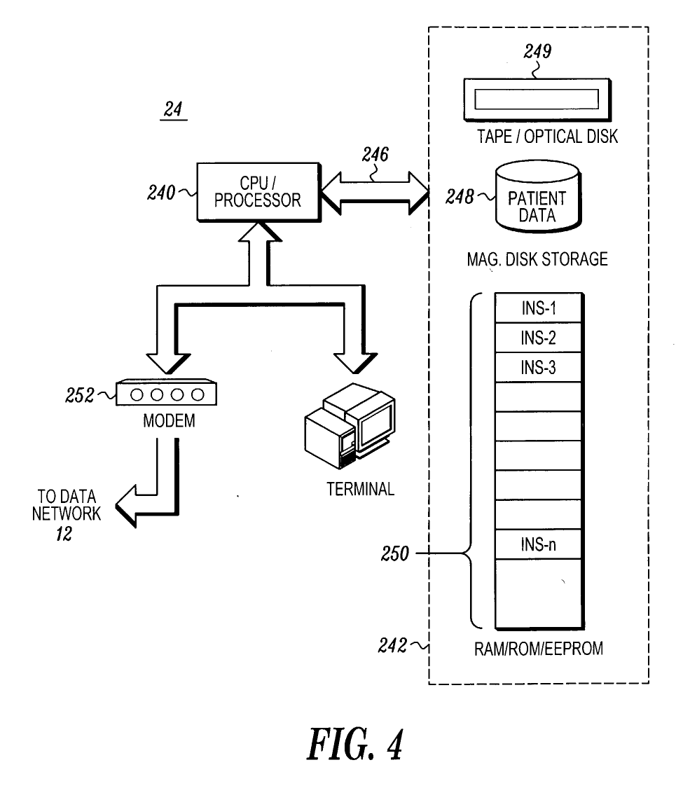

With respect to the system 10 shown in FIG. 1, the patient data processing computer 24 is an appropriately capable processor and memory wherein program instructions and data are stored. FIG. 4, which is discussed more fully below, depicts elements of a patient data processing computer 24. The patient-data processing computer 24 can be embodied as a web site server, into which data can be uploaded and from which data can be downloaded via the data network 12.

The patient data processing computer 24, performs a variety of functions on the patient data that is sent to it from the health care providers 22. When the instructions are executed, the instructions give the processor of the computer 24 certain functionality that is explained more fully below.

As set forth above, in the system 10 depicted in FIG. 1, patient data is entered into the point-of-care data terminals 14, 16, 18, 20 and 28 and then routed by those systems via the data network 12 to a remotely-located computer 24 where the patient data is processed. The aforementioned patient data can be “processed” either before or after the patient data is stored on a disk drive 26 or other storage media.

Among other things, patient data can be “processed” by the computer 24 or the computer 31 to de-identify and re-identify patient data. In instances where patient data collected by a medical practice group and stored on the computer/server 31 is not transmitted outside the practice group, de-identification might not be necessary or required by either the patient, statute or governmental regulations.

De-identifying patient data means removing all information in the patient data from the health care providers from which a person can be identified, either directly or indirectly. Certain statutory requirements prohibit the distribution of information from which a medically-treated person can be identified and/or associated with his/her medical information. De-identifying patient data therefore becomes important in the system 10.

Patient data can be de-identified by suppressing any information by which a person can be identified and associated with medical information. Inasmuch as patient data will almost always be stored in a data structure or file, the organization of which will be known, writing over or masking information by which an individual can be identified is readily accomplished. When patient data is de-identified, the de-identified data is preferably tagged or marked or indexed and then associated with a different data structure or file that stores the patient identity so that de-identified patient data can later be re-identified.

Re-identifying patient data is simply the opposite of de-identifying and can be done when the statutory requirements so require for instance, when the patient gives explicit permission or the data is by the health care provider for his/her care. For example, a patient's medical data would be stored by the health care provider in an identified form so that individual care could be rendered. De-identified clinical details such as medical problems and medications could be sent to data processing computer 24 from either a point-of-care terminal or another computer/server 31, with a re-identification pointer retained with the health care provider, e.g., by or within the point-of-care terminal or a local computer/server 31. If a dangerous medication trend was noted on the aggregated data, that information could be returned to the individual health care providers who provided de-identified patient data and who could then use the re-identification table to notify the patient.

In addition to de-identifying patient data, the patient data processing computer 24 can process patient data including sorting, filtering, organizing and analyzing patient data to augment the provision of medical care. In one preferred embodiment, the patient data processing computer 24 processes patient data to identify potential subjects for medical research by identifying individuals with certain characteristics that might be of interest to medical researchers, pharmaceutical companies, governmental agencies and the like.

By having the computer 24 collect pertinent data from perhaps hundreds of healthcare providers, each of whom might see hundreds or thousands of patients per month, the computer 24 can provide a computerized central data collection and storage point. Having large amounts of patient data that can be scanned and processed by a computer enables the computer and/or it's software to perform a very wide variety of tasks s according to any criteria by which patients can be identified. As set forth above, patient data in data bases stored in the computers 24 and 31 can be analyzed to derive new guidelines on medical care and procedures using evidence in the form of patient data.

By way of example, drug manufacturers seeking FDA approval of a new pharmaceutical typically need to establish the safety and efficacy of a drug prior to it's approval. Qualifying test subjects might be identified by age, medical condition, gender, personal lifestyle, or any other information. If information by which a potential test subject can be identified is provided to the computer 24 or 31, the computer 24 or 31 can identify each such person by simply scanning its data records to identify records of individuals having a particular characteristic. If a patient qualifies for a research study, notification can be returned to the health care provider at the point of care, whereupon the patient can be queried as to whether he or she wishes to participate in a medical study. In instances where healthcare information from medical providers is de-identified, the computer 24 or 31 can also re-identify patients from among the patients' information submitted to it in order to enable a healthcare provider to contact certain patients under certain circumstances. Another function of the computer 24 and/or 31 therefore is to re-identify patients from de-identified data that was previously transmitted

De-identified patient data preferably includes the aforementioned data albeit devoid of any information from which a third party could identify the patient to whom it pertains. In a preferred embodiment, de-identified patient data is associated with, linked to, or appended with a scalar that is a pointer into a table. When data for a particular patient needs to be re-identified, the pointer that was associated with, linked to, or appended to patient data can be used to re-identify the patient data using the pointer to a table entry where the patient's identifying information can be kept, or it's location identified.

In another embodiment of the system 10, “processing” patient data obtained from the healthcare providers includes operations by the computer 24 or 31 to detect the possibility of adverse drug interactions by statistics obtained from patient data and possibly from outside sources such a pharmaceutical manufacturers, clinical laboratories for blood analysis or the Food and Drug Administration. By way of example, patient data records from healthcare providers 22 regarding medical treatments that were provided to one or more of their patients can be uploaded to the computer 24 via the network 12. Patient data can be used to derive or identify optimal drug treatments and/or treatments to avoid. For instance, a blood or body sample analysis that determines a patient's genetic pattern might be used to predict which treatments he/she is likely to respond to or to which drugs he/she will have side effects from.

In another embodiment of the system 10, processing patient data obtained from the healthcare providers includes a determination by the computer 24 or 31 of optimal treatment recommendations by statistics obtained from patient data and possibly from outside sources such medical journals or the Food and Drug Administration. By way of example, patient data records from healthcare providers 22 regarding medical treatments that were provided to one or more of their patients can be uploaded to the computer 24 via the network 12 or computer 31 via a local network.

Patient data can be processed to derive or identify preferred medical treatments, avoiding drug interactions and the like, which might be useful in subsequent medical treatment regimens by a health care provider. By way of example, abnormal blood cholesterol levels could be identified from blood laboratory analysis and presented to the health care provider. A health care provider's treatment recommendations for the abnormal blood cholesterol may or may not be made based on a analysis of other medical conditions of the patient and the patient's response and possibly treatment side effects would be monitored. The health care provider would then receive feedback as to the adequacy of treatment for the abnormal blood cholesterol treatment for this patient or possibly all of his/her appropriate patients (a health care provider report card). In the aggregate, information as to the adequacy of the recommendations from other sources could be made available for group comparisons or benchmarking and to improve the recommendations. That a health care provider conformed to generally-accepted or recommended courses of actions can be substantiated at a later date.

Patient data can be used and also processed by either the computer 24 or 31 to derive or identify a patient's response to (or his/her compliance with) generally accepted medical practices for the patient, government-spohsored treatment recommendations and/or insurer recommended courses of action for treatments of various diseases or conditions of the patient. For instance, it is known that greater than 50% of patients with heart failure do not comply with recommended dietary, medical and lifestyle recommendations. Recursive data from the health care providers office, patient or patient's surrogate's residence could be used to optimize compliance or warn through the system when the patient was not compliant. For instance, if the patient did not pick up his/her prescription or refill.

As shown in FIG. 1, data pathways 15, 19, 21, 25, 27 and 29 between the point-of-care data terminals 14, 16, 18, 20 and 28 (respectively) and the data network 12 are bi-directional. Similarly, the data pathway 32 between the computer 24 and the data network 12 is bi-directional by which information can be exchanged between health care providers and the computers 24 and 31.

In the system 10 depicted in FIG. 1, at least some of the processed patient data and/or other information derived from the processed patient data (both of which are considered to be at least some processed patient data) can be returned to the healthcare providers 22 via the data network 12 for their use in evaluating the efficacy of a treatment regimen or modifying or changing a treatment regimen in response to information sent to them from the computer 24.

As shown in FIG. 1, the pathways between the point-of-care terminals 14, 16, 18, 20 and 28 and the data network 12 can take many forms. The pathways 25 and 27 between point-of-care terminals 18 and 20 respectively are shown as hard-wired connections. The pathway 15 between the point-of-care terminals 14 and a server 31 is shown as a wireless data link. Similarly, the pathway between the point-of-care terminal 28 and the network 12 is shown as a wireless data link 29. Server 31 is coupled to a point-of-care data collection system 16 via a hard-wired data link 19. The server 31 in such an embodiment can act as a local, patient data collector.

The servers 24 and 31 can be embodied as one or more computers and/or software for one or more health care providers, such as a group of cardiac care specialists, whom can be located in one or more offices, hospitals, clinics or at their residences. The server 31 can provide patient data to, and store patient data from one or more point-of-care data terminals 14, 16, 18 whether such systems 14, 16 and 18 are hard-wired or wirelessly coupled to the server 31. The server 24 can directly or indirectly collect patient data from one or more point-of-care collection systems 20 and 28, but also from the server 31, which functions to provide a server that is “local” to point-of-care terminals.

As is known in the data network art, data can be transferred continuously or in batches. The patient data collected at the server 31 can also be continuously uploaded to the server/computer 24 or in batches via data links 27 and 29, the data network 12 and a data link 32 between the server 24 and the network 12. Similarly, data can uploaded to the server/computer 24 from the first server 31 either continuously or in batches, via the data link 21, the network 12 and data link 32.

When the data network 12 is embodied as a wide area network such as the Internet, patient data can be readily uploaded and downloaded from virtually anywhere. Processed patient data can be posted to a secure web site provided by software within the serve 24 or using resources provided by another server (not shown). Information obtained from processing patient data, whether it is de-identified or not, can be widely distributed to health care providers, patients, governmental agencies, hospitals, educational institutions and any other entity that might be interested in obtaining the information.

By collecting patient data from perhaps hundreds of healthcare providers that were derived from medical treatments provided to perhaps hundreds or thousands of patients, treatment regimens for a variety of illnesses can be correlated with their effectiveness and the results of those comparisons relayed back to the healthcare providers 22 augmenting the healthcare provided to the patient.

In other embodiments, patient data can be obtained from a single health care provider, or numerous health care providers, identifying medical treatment or treatments provided to as few as a single patient, or numerous patients. Such patient data can be uploaded to the computer 24 for processing and returned to one or more healthcare providers via the data network as set forth above.

In at least one preferred embodiment, processed patient data can be provided to third-party patient data consumers such as drug manufacturers and medical equipment manufacturers, governmental agencies, schools, insurance providers, hospitals, health maintenance organizations and others. Third-party patient data consumers can further process patient data by, among other things, adding additional information to the processed patient data. By collecting the medical records of perhaps hundreds of patient data records from numerous healthcare providers 22, the efficacy of medical treatment can be monitored over time and, if necessary, demonstrated as more or less effective or perhaps ineffective by the computer's 24 manipulation and processing of data in the medical records sent to it from health care providers. Processed and de-identified patient data can be forwarded to a third party or third party computer 30 via the link 32 coupling the computer 24 to the network 12, or, via a link 36 between the patient data processing computer 24 and the computer 30 of a third party/

As set forth above, in some instances, a third party (represented by the third party computer 30) might be a governmental agency such as the Food and Drug Administration. A third party that receives processed patient data can include a drug manufacturer, a medical device manufacturer, a medical research institution, a medical school or university, or any other entity which might have use for processed patient data, subject of course to compliance with pertinent statute and regulatory requirements prohibiting the dissemination of medical information by which individuals can be identified.

In yet other embodiments, the process of patient data generated by the computer 24 can be used to market healthcare services and/or insurance, or to improve patient safety by keeping up-to-date data on health care regimens and their efficacy. For instance, a medical device manufacturer of a product for a certain condition might use the aggregated date to determine the potential market or regional variations. As such, patient data can also be used to improve patient safety. For instance, by monitoring side effects of drugs, treatment regimens or devices, as enabled by the wide collection of numerous data records, dangerous therapies can be detected by analyzing data collected by healthcare professionals on similar subjects. For instance, many drugs have potential side effects that can be monitored by periodic blood analysis. The system could prompt the health care provider, patient or patient surrogate if the blood analysis is incomplete or abnormal.

In yet another embodiment, the provision of patient data by one or more healthcare providers can be used to obtain healthcare consulting services from one or more health care specialists. By way of example, a healthcare provider 22, such as a cardiac care specialist, might wish or need to consult with other medical professionals. By providing patient data via the Internet, the patient data can be distributed virtually anywhere, including to health care specialists from whom consulting services can be rendered. In such an embodiment, the computer identified in FIG. 1 by reference numeral 30 could also correspond to a computer/server operated and/or accessed by a consulting specialist.

In yet another embodiment, patient data that might be provided to a third party can be further processed or reprocessed by the third party for additional value, such as additional analysis. In such an embodiment, a drug manufacturer can employ its own data processing algorithms on the patient data in an attempt to extract or derive information from the patient data obtained from various healthcare providers. In such an alternate embodiment, the drug manufacturer can make its re-processed patient data available to the computer 24. From there, the re-processed patient data can be distributed to health care providers, patients or other third-party patient data consumers.

Of course, statutory requirements related to patient privacy must be followed but in yet another embodiment, patient data obtained from several healthcare providers and which is processed to spot dangerous treatments can have that data re-identified for use in notifying patients who might be in danger or at risk from latent safety risks in a drug treatment, device or treatment regimen. Therefore, re-identifying patient data either the computer 24 or the point-of-care data collection systems, healthcare providers 22 can be used to notify patients who might be at risk or in danger.

FIG. 4 shows a block diagram of a patient data processing computer 24 shown in FIG. 1, albeit in greater detail. A central processor unit or processor 240 is coupled to a memory 242 via an address and control bus 246. The processor 240 can be embodied as one or more micro-controllers, micro-processors or other devices capable of reading data and instructions from the memory 242 and responding appropriately thereto.

The memory 242 shown in FIG. 4 has at least three different types of storage media, all of which perform the separate functions of: i) storing data and ii) instructions that can be executed by the processor 240. As is well-known to those of ordinary skill in the art of programmable computers, instructions 250 stored in memory 242 are binary values. Those of skill in the art will recognize that instructions and data could be stored in other media capable of storing more than binary-valued information, which should be considered to be equivalent to the memory 242. They are recognized by the processor as instructions and cause the processor 240 to do something, such as add or subtract a number; compare two values together; test a value, etc. In the preferred embodiments of the invention disclosed herein, by virtue of the instructions 250 stored therein, the memory can be considered as having a function that is to cause the processor to perform certain operations exemplified by the stored instructions.

Among the things set forth above, the instructions 250 stored in memory 252 cause the processor 240 to receive patient data via the data network 12 through a modem or other communications device 252 that is also operatively coupled to the processor 240. The program instructions 250 also cause the processor 240 to process patient data 248 to perform certain operations thereon.

Examples of the operations that can be performed on the patient data 248 include, de-identification of patient data, so as to comply with the statutory and regulatory requirements protecting the privacy of individuals who are treated by healthcare professionals. In addition, the processor 240 can be programmed/controlled by the stored program instructions 250 to correlate medical treatments and their efficacy as reported by one or more healthcare providers 22 as shown in FIG. 1. Stored program instructions 250 can also cause the processor to augment disease prevention and healthcare management by detecting dangerous or other unsafe combinations of drugs, therapies or devices from the patient data reported to the computer 24 as set forth above.

Patient data 248 can be processed according to the stored program instructions to identify potential subject for medical research, obtain regulatory approval for medical devices and treatments and for use in healthcare marketing and patient safety. “Marketing” purposes could include comparative announcements or advertisements of a medical practice that provides unique treatments or improved treatments for patients enabled by the system and method disclosed herein.

The stored program instructions 250 can also control the processor 240 to provide patient data (whether de-identified or not) for use by public safety organizations to detect early onset of epidemics or biological or chemical acts of terrorism and thereby facilitate or expedite appropriate responses of public safety and public health agencies. By way of example, a simultaneous or near-simultaneous reporting of certain diseases or infections from healthcare providers in a geographic area could suggest an outbreak of the disease; treatments of prescriptions issued for certain medical treatments (e.g., CIPRO®) can also indicate an outbreak or outbreak threat. By detecting treatments ordered by state-licensed health care professionals, a governmental agency, such as the Centers for Disease Control (CDC) might determine that preemptive inoculations or treatments in the effected area or in other geographic are necessitated by the particular disease or condition.

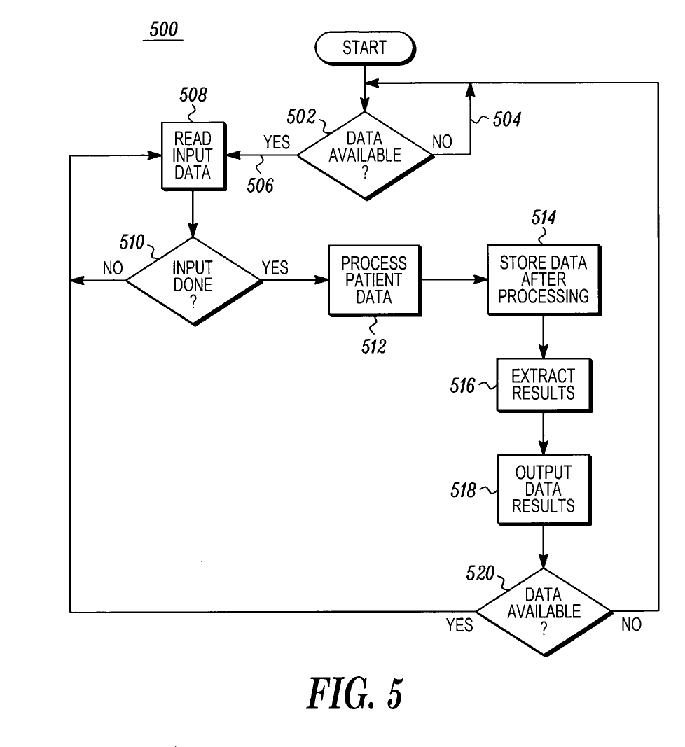

FIG. 5 shows steps of a method for obtaining healthcare information, processing the information to extract information or knowledge from it and then distributing the information/knowledge. The process steps of FIG. 5 can be performed by either server 24 or 31.

In step 502, the server waits in a loop 504 until patient data/information is available such as from one of point of care data terminals or from a server 31 that collects patient data from such terminals. As set forth above, the patient data collected from patients using the point-of-care data terminals is clinical data, related to disease prevention and/or management as opposed to billing information for instance. When patient data becomes available 506, the server performing the process 500 reads the data in step 508 until the input patient data in determined to be complete in step 510.

When all of the available patient data has been collected, the data is processed in step 512 to extract information and/or knowledge from the patient data. By way of example, patient data obtained in step 508 obtained from several physicians might indicate or suggest that male patients, over a certain age with a history of high blood pressure are suffering abnormally high incidences of stroke when they are taking two particular medications. The processing that can be performed in step 512 is virtually limitless.

After processing in step 512, the processed patient data is stored, such as on disk, from which it can be later retrieved. (In an alternate embodiment, patient data can be stored prior to processing.) Upon a query from a remote health care provider, or under software control, results obtained from the processing 512 and stored in memory 514 can be extracted in step 516 for distribution.

The extracted results are shown as being output or “provided” in step 518 such that the results of the processing is distributed to health care providers, third-party patient data consumers or others.

Step 520 shows a decision being made to detect whether more patient information is available. In a sense, the processing loop of steps 508, 512 and 516 continually calls for the input of new information from health care providers such that the patient information processing is continually using up-to-date information to render the most timely medical information and knowledge possible. In a sense, the patient data is processed an d information is extracted recursively in that new patient data is obtained as part of the processing of, and information extraction from previously-obtained patient data.

As set forth above, prompt reporting disease and/or infection to a centralized data collection server via a data network, as enabled by the system 10 and it's components, can help identify outbreaks of disease and public safety health care risks. Whether such threats are valid or not, even a suspicion that an outbreak is incipient can significantly improve health care. Outbreak risks can be posted by the server/computer 24 onto a website, sent directly to healthcare providers, or to public safety/public health agencies in affected or threatened areas.

As set forth above, processed patient data can be provided to third-party data consumers, such as insurance companies, public safety agencies, regulatory agencies and the like. Processed patient data can also be provided to medical research facilities, medical colleges and/or other healthcare providers.

Patient data collection by health care providers can be incentivized and/or required. Incentivizing health care providers might be accomplished by simply requiring data submission as a prerequisite to system access. In yet another embodiment, health care providers can be financially incentivized by for example, providing a point-of-care data terminals 50 on preferred terms and/or conditions. In yet another embodiment, the health care providers 22 can be incentivized simply by being provided with information gleaned from processed patient data, i.e., by changing raw patient data records into educational information, such as a warning about possible side effects of a drug, or, a warning of previously-unknown drug interactions detected by statistics that show patients taking two particular medications experience a high-number of adverse reactions. Healthcare providers can be incentivized by embellishments or enhancements to already-known guidelines and by which a professional health care provider can improve his or her knowledge in a particular field and hence the quality of his or her care. An improved quality of care, as documented by the system 10, can be used to provide financial incentives by patient health care insurers or governmental agencies that provide health care reimbursement or insurance.

In yet other embodiments, health care providers 22 can be incentivized by access to consulting services from one or more experts, who make themselves available to health care providers at the expense of the owner/operator of the computer 24, or of a drug manufacturer or medical device manufacturer. Direct payments of money can also incentivize a health care provider to collect patient data and up load it to the computer 24.

The cost of providing patient data collection incentives to health care providers can be at least partially recovered by selling processed patient data and/or access to “processed” (as claimed). patient data. As set forth above, raw, unprocessed patient data records can be processed to yield improved medical techniques, medical care guidelines or other enhancements and provided to medical care providers as an inducement to provide yet additional data. The cost to provide patient data processing services can also be recovered by selling the aforementioned up-to-date medical care information gleaned from raw patient data might also sold. By way of example, a manufacturer of cardiac pacemakers might find it helpful to track the patients into whom a particular pacemaker was installed. If the health care providers capture such information and provide it to the patient data processing computer(s) 31 or 24, the cardiac pacemaker manufacturer might find it valuable to track the long-term usage of its products and be willing to provide payment or other “consideration” to a medical data service provider. Such “consideration” can be provided in whole or in part to the health care providers who collect the patient data.

By using the foregoing method and apparatus for obtaining and providing healthcare information, healthcare can be improved by providing a feedback to healthcare providers, of medical conditions, treatments, and their efficacy. In other words, by providing a closed loop feedback system of information obtained from numerous healthcare providers, that data can be examined under computer control to measure efficacy of a medical treatment or treatments, recommend better or more up-to-date treatments, and track improvements or degradation in medical treatment caused by or attributable to variations thereof.

What is claimed is:

1. A method of obtaining and providing healthcare information, the method comprising the steps of:
obtaining patient data from a health care provider via a data network, said patient data identifying medical treatment provided to a patient by the healthcare provider;
processing patient data from the health care provider to form processed patient data; and
providing at least some of the processed patient data to a health care provider via the data network.

2. The method of claim 1 wherein processing patient data includes determining a health care provider's compliance with health care treatment guidelines.

3. The method of claim 1 wherein the step of processing patient data from the health care provider includes the step of de-identifying said patient data.

4. The method of claim 1 wherein the step of processing patient data from the health care provider includes the step of re-identifying said patient data.

5. The method of claim 1 further including the step of obtaining patient data from a point-of-care data terminal.

6. The method of claim 1 wherein the patient data is obtained and processed recursively to extract clinical information from the patient data.

7. The method of claim 1, wherein the step of providing at least some of the processed patient data includes the step of providing processed patient data regarding potential subjects for medical research.

8. The method of claim 1, wherein the step of providing at least some of the processed patient data includes the step of providing processed patient data that is related to at least one of: disease prevention and disease management.

9. The method of claim 1, wherein the step of providing at least some of the processed patient data includes the step of providing processed patient data for use in obtaining regulatory approval for a medical treatment.

10. The method of claim 1, wherein the step of providing at least some of the processed patient data includes the step of providing processed patient data used in healthcare marketing.

11. The method of claim 1, wherein the step of providing at least some of the processed patient data includes the step of providing processed patient data regarding patient safety.

12. The method of claim 2, further including the step of combining patient data with third-party data to determine a health care provider's compliance with health are treatment guidelines.

13. The method of claim 1 further including the step of de-identifying patient data prior to providing at least some of the processed data.

14. The method of claim 1 wherein the step of processing patient data from the health care provider includes the step of providing healthcare consulting service to the health care provider.

15. A method of obtaining and providing healthcare information, the method comprising the steps of:
obtaining patient data from a plurality of health care providers via a data network, said patient data identifying medical treatment provided to a plurality of patients who were treated by the plurality of health care providers;
processing said patient data to form processed patient data; and
providing processed patient data to at least one health care provider via the data network.

16. The method of claim 15 wherein processing patient data includes determining a health care provider's compliance with recommended treatment guidelines.

17. The method of claim 15 wherein the step of processing said patient data includes the step of de-identifying said patient data.

18. The method of claim 15 wherein the step of processing said patient data includes the step of re-identifying said patient data.

19. The method of claim 15 further including the step of obtaining patient data from a point-of-care data terminal.

20. The method of claim 19 wherein the point-of-care terminal is provided to a health care provider on agreement by the healthcare provider to provide patient data.

21. The method of claim 15, wherein the step of providing at least some of the processed patient data includes the step of providing processed patient data regarding potential subjects for medical research.

22. The method of claim 15, wherein the step of providing at least some of the processed patient data includes the step of providing processed patient data that is related to disease prevention and management.

23. The method of claim 15, wherein the step of providing at least some of the processed patient data includes the step of providing processed patient data for use in obtaining regulatory approval for a medical treatment.

24. The method of claim 15, wherein the step of providing at least some of the processed patient data includes the step of providing processed patient data used in healthcare marketing.

25. The method of claim 15, wherein the step of providing at least some of the processed patient data includes the step of providing processed patient data regarding patient safety.

26. The method of claim 16 further including the step of combining third-party data with patient data to determine a health care provider's compliance with a recommended treatment guideline.

27. The method of claim 16 further including the step of de-identifying patient data prior to the step of providing at least some of the processed data.

28. The method of claim 15 wherein the step of processing patient data from the health care provider includes the step of providing healthcare consulting service to the health care provider.

29. A method of obtaining and providing healthcare information, the method comprising the steps of:
obtaining patient data from a plurality of health care providers via a data network, said patient data for medical treatment provided to a plurality of patients by the plurality of health care providers;
processing patient data from the health care provider to form processed patient data; and
providing at least some of the processed patient data to a third party via the data network.

30. The method of claim 29 further including the step of: receiving from a third party, further-processed patient data.

31. The method claim 30 further including the step of sending the further-processed patient data to a health care provider via the data network.

32 The method of claim 31 further including the step of combining additional data with the further-processed patient data.

33. The method of claim 29 further including the step of determining a health care provider's compliance with recommended treatment.

34. The method of claim 29 wherein the step of processing said patient data includes the step of de-identifying said patient data.

35. The method of claim 29 wherein the step of processing said patient data includes the step of re-identifying said patient data.

36. The method of claim 29 further including the step of obtaining patient data from a plurality of patients using at least one, point-of-care data terminal.

37. The method of claim 36 wherein the point-of-care terminal is provided to a health care provider on agreement by the healthcare provider to provide patient data.

38. The method of claim 29, wherein the step of providing at least some of the processed patient data includes the step of providing processed patient data regarding potential subjects for medical research.

39. The method of claim 29, wherein the step of providing at least some of the processed patient data includes the step of providing processed patient data that is related to disease treatment.

40. The method of claim 29, wherein the step of providing at least some of the processed patient data includes the step of providing processed patient data for use in obtaining regulatory approval for a medical treatment.

41. The method of claim 29, wherein the step of providing at least some of the processed patient data includes the step of providing processed patient data used in healthcare marketing.

42. The method of claim 29, wherein the step of providing at least some of the processed patient data includes the step of providing processed patient data regarding patient safety.

43. The method of claim 30, wherein the step of storing patient data further comprises the step of: de-identifying patient data prior to the step of storing.

44. The method of claim 30, wherein the step of storing patient data further comprises the step of: de-identifying patient data prior to the step of providing at least some of the processed data.

45. The method of claim 29 wherein the step of processing patient data includes the step of providing healthcare consulting service to the third party.

46. A method of obtaining and providing healthcare information, the method comprising the steps of:
obtaining at a first server via a data network, patient data from a plurality of health care providers, said patient data related to medical treatment provided to a plurality of patients by the plurality of health care providers;
processing patient data from the plurality of health care providers to form processed patient data; and
providing the processed patient data to a third party via the data network, said third party further processing said processed patient data; and
receiving via the data network at said first server from the third party, said further-processed patient data.

47. The method of claim 46 wherein processing patient data includes determining a health care provider's compliance with recommended treatment guidelines.

48. The method of claim 46 wherein the step of processing said patient data includes the step of de-identifying said patient data.

49. The method of claim 46 wherein the step of processing said patient data includes the step of re-identifying said patient data.

50. The method of claim 46 further including the step of obtaining patient data from a plurality of patients using at least one, point-of-care data terminal.

51. The method of claim 50 wherein the point-of-care terminal is provided to a health care provider on agreement by the healthcare provider to provide patient data.

52. The method of claim 46, wherein the step of providing at least some of the processed patient data includes the step of providing processed patient data regarding potential subjects for medical research.

53. The method of claim 46, wherein the step of providing at least some of the processed patient data includes the step of providing processed patient data that is related to disease prevention and management.

54. The method of claim 46, wherein the step of providing at least some of the processed patient data includes the step of providing processed patient data for use in obtaining regulatory approval for a medical treatment.

55. The method of claim 46, wherein the step of providing at least some of the processed patient data includes the step of providing processed patient data used in healthcare marketing.

56. The method of claim 46, wherein the step of providing at least some of the processed patient data includes the step of providing processed patient data regarding patient safety.

57. The method of claim 47 further including the step of de-identifying patient data prior to storing the patient data.

58. The method of claim 47 further including the step of storing patient prior to the step of providing at least some of the processed data.

59. The method of claim 46 wherein the step of processing patient data includes the step of providing healthcare consulting service to the third party.

60. A device for collecting and distributing healthcare data comprising:
a processor;
memory, operatively coupled to said processor and storing program instructions which when executed cause the processor to:
receive patient data that relates to medical treatment provided to a patient by a healthcare service provider;
manipulate patient data to form processed patient data;
provide at least some of the processed patient data to third-party patient data consumers.

61. The device of claim 60 further comprised of memory storing program instructions which, when executed, cause the processor to store patient data in a storage device;

62. The device of claim 60 further comprised of a point-of-care terminal, operatively coupled to said processor and by which patient data is collected from a patient.

63. The device of claim 60 further including program instructions, which when executed cause the processor to manipulate patient data to de-identify a patient that is identified by said patient data.

64. The device of claim 60 wherein said processor is capable of functioning as a web server.

65. The device of claim 60 further including a point-of-care data terminal, operatively coupled to said processor.

66. The device of claim 60 wherein the memory stores program instructions which when executed, cause the processor to store data that is obtained from a health care provider on agreement by the healthcare provider to provide patient data in exchange for consideration.

67. The device of claim 60 wherein the memory stores program instructions that cause the processor to process patient data regarding potential subjects for medical research.

68. The device of claim 60 wherein the memory stores program instructions that cause the processor to process patient data that is related to disease prevention and management.

69. The device of claim 60 wherein the memory stores program instructions that cause the processor to process patient data for use in obtaining regulatory approval for a medical treatment.

70. The device of claim 60 wherein the memory stores program instructions that cause the processor to process patient data used in healthcare marketing.

71. The device of claim 60 wherein the memory stores program instructions that cause the processor to process patient data regarding patient safety.

72. A system for collecting and distributing patient healthcare data, said system comprising:
a point-of-care data terminal by which patient data is collected from a patient;
a server, operatively coupled to said point-of-care data terminal, and operatively coupled to memory wherein program instructions are stored, said server being programmed by stored program instructions to:
receive patient data from the point-of-care terminal that relates to medical treatment provided to a patient;
manipulate patient data to form processed patient data;

73. The system of claim 72 wherein said server is additionally programmed to:
store the patient data in a storage device.

74. The system of claim 72 wherein said server is additionally programmed to:
provide at least some of the processed patient data to third-party patient data consumers.

75. The system of claim 72 wherein said server is programmed to receive patient data that relates to at least one of: disease control and disease management.

76. The system of claim 72 wherein said server is programmed to receive patient data that relates to medical research.

77. The system of claim 72 wherein said server is programmed to receive patient data that relates to regulatory approval of a medical treatment.

78. The system of claim 72 wherein the memory stores program instructions that cause the processor to process patient data that is related to disease prevention and management.

79. The system of claim 72 wherein the memory stores program instructions that cause the processor to process patient data used in healthcare marketing.

80. The system of claim 72 wherein the memory stores program instructions that cause the processor to process patient data regarding patient safety.

81. A system for collecting and distributing patient healthcare data, said system comprising:
a processor, operatively coupled to a data network and capable of receiving patient data from the network;
a memory, operatively coupled to said processor, said memory storing program instructions, which when executed cause said processor to:
receive, via said data network, patient data for a plurality of patients, said patient data originating from a plurality of point-of-care terminals, said patient data related to medical treatment provided to said patients by health care providers;
processing patient data to yield analyzed and de-identified patient data;
providing analyzed patient data to at least one of:
i) third-party patient data-consumers; and
ii) health care providers.

82. The system of claim 81 further including at least one point-of-care data terminal operatively coupled to said data network and by which patient data is collected from a patient, said point-of-care data terminal sending patient data to said first computer means via said data network.

83. A computer for collecting and distributing healthcare data, said computer comprising:
a processor, operatively coupled to a data network;
memory, operatively coupled to said processor and storing program instructions, which when executed cause the processor to:
receive via said data network, patient data that relates to medical treatment provided to a patient by a healthcare service provider;
process patient data to form processed patient data;
provide at least some of the processed patient data to at least one of:
i) third-party patient data consumers;
ii) a health care provider.

84. The computer of claim 83 further comprised of memory storing program instructions which, when executed, cause the processor to store patient data in said memory.

85. The computer of claim 83 further including program instructions, which when executed cause the processor to de-identify patient data.

86. The computer of claim 83 further including program instructions, which when executed cause the processor to re-identify patient data.

87. The computer of claim 83 wherein said computer is a web server which can distribute processed patient data via the Internet.

88. The computer of claim 83 further including a point-of-care data terminal operatively coupled to said computer via a data network.
